(19) United States
(12) Patent Application Publication
(10) Pub. No.: US 2020/0264011 A1
(43) Pub. Date: Aug. 20, 2020

(54) DRIFT CALIBRATION METHOD AND DEVICE FOR INERTIAL MEASUREMENT UNIT, AND UNMANNED AERIAL VEHICLE

(71) Applicant: SZ DJI TECHNOLOGY CO., LTD., Shenzhen (CN)

(72) Inventors: Qingbo LU, Shenzhen (CN); Chen LI, Shenzhen (CN); Lei ZHU, Shenzhen (CN); Xiaodong WANG, Shenzhen (CN)

(21) Appl. No.: 16/854,559

(22) Filed: Apr. 21, 2020

Related U.S. Application Data
(63) Continuation of application No. PCT/CN2017/107812, filed on Oct. 26, 2017.

(51) Int. Cl. G01C 25/00; G06T 7/246; G06K 9/46; B64C 39/02; B64D 47/08; G01C 21/16

(52) U.S. Cl. CPC G01C 25/00; G06T 7/246; G06K 9/46; B64C 39/024; B64C 2201/14; G01C 21/16; G06T 2207/30248; G06T 2207/10016; B64C 2201/127; B64D 47/08

(57) ABSTRACT

Method and device for drift calibration of an inertial measurement unit, and an unmanned aerial vehicle are provided. The drift calibration method includes obtaining video data captured by a photographing device; and determining a measurement error of the inertial measurement unit according to the video data and rotation information of the inertial measurement unit when the photographing device capturing the video data. The rotation information of the inertial measurement unit includes the measurement error of the inertial measurement unit.

### CROSS-REFERENCE TO RELATED APPLICATION

This application is a continuation of International Application No. PCT/CN2017/107812, filed on Oct. 26, 2017, the entire content of which is incorporated herein by reference.

### TECHNICAL FIELD

The present disclosure relates to the field of unmanned aerial vehicle and, more particularly, to a drift calibration method and drift calibration device, of an inertial measurement unit, and an unmanned aerial vehicle.

### BACKGROUND

An inertial measurement unit (IMU) is often used to detect motion information of a movable object. Under the influence of environmental factors, a measurement result of an IMU has a certain drift problem. For example, an IMU can still detect motion information when the IMU is stationary.

To solve the drift problem of the measurement result of the IMU, the existing technologies calibrate measurement error of the IMU by an off-line calibration method. For example, the IMU is placed at rest and a measurement result outputted by the IMU is recorded. Then the measurement result outputted by the stationary IMU is used as the measurement error of the IMU. When the IMU detects the motion information of the movable object, actual motion information is obtained by subtracting the measurement error of the IMU from a measurement result outputted by the IMU.

However, the measurement error of the IMU may change with changing environmental factors. When the environmental factors where the IMU is located change, the calculated actual motion information of the movable object would be inaccurate if the fixed measurement error of the IMU is used.

### SUMMARY

One aspect of the present disclosure provides a drift calibration method. The method includes: obtaining video data captured by a photographing device; and determining a measurement error of the inertial measurement unit according to the video data and rotation information of the inertial measurement unit when the photographing device capturing the video data. The rotation information of the inertial measurement unit includes the measurement error of the inertial measurement unit.

Another aspect of the present disclosure provides a drift calibration device. The drift calibration device includes a memory and a processor. The memory is configured to store programming codes. When the program codes being executed, the processor is configured to obtain video data captured by a photographing device and determine a measurement error of the inertial measurement unit according to the video data and rotation information of the inertial measurement unit when the photographing device capturing the video data. The rotation information of the inertial measurement unit includes the measurement error of the inertial measurement unit.

Another aspect of the present disclosure provides an unmanned aerial vehicle. The unmanned aerial vehicle includes: a fuselage, a propulsion system on the fuselage, to provide flying propulsion; a flight controller connected to the propulsion system wirelessly, to control flight of the unmanned aerial vehicle; a photographing device, to photograph video data; and a drift calibration device. The drift calibration device includes a memory and a processor. The memory is configured to store programming codes. When the program codes being executed, the processor is configured to obtain video data captured by a photographing device and determine a measurement error of the inertial measurement unit according to the video data and rotation information of the inertial measurement unit when the photographing device capturing the video data. The rotation information of the inertial measurement unit includes the measurement error of the inertial measurement unit.

In the present disclosure, when the photographing device captures the video data, the rotation information of the IMU during the photographing device captures the video data may be determined. The rotation information of the IMU may include the measurement error of the IMU. Since the video data and the measurement result of the IMU can be obtained accurately, the determined measurement error of the IMU according to the video data and the rotation information of the IMU may be accurate, and a computing accuracy of the moving information of the movable object may be improved.

Other aspects or embodiments of the present disclosure can be understood by those skilled in the art in light of the description, the claims, and the drawings of the present disclosure

### BRIEF DESCRIPTION OF THE DRAWINGS

FIG. 1 illustrates an exemplary drift calibration method for an inertial measurement unit consistent with various embodiments of the present disclosure;

FIG. 2 illustrates video data consistent with various embodiments of the present disclosure;

FIG. 3 illustrates other video data consistent with various embodiments of the present disclosure;

FIG. 4 illustrates another exemplary drift calibration method for an inertial measurement unit consistent with various embodiments of the present disclosure;

FIG. 5 illustrates another exemplary drift calibration method for an inertial measurement unit consistent with various embodiments of the present disclosure;

FIG. 6 illustrates another exemplary drift calibration method for an inertial measurement unit consistent with various embodiments of the present disclosure;

FIG. 7 illustrates another exemplary drift calibration method for an inertial measurement unit consistent with various embodiments of the present disclosure;

FIG. 8 illustrates another exemplary drift calibration method for an inertial measurement unit consistent with various embodiments of the present disclosure;

FIG. 9 illustrates an exemplary drift calibration device for an inertial measurement unit consistent with various embodiments of the present disclosure; and

FIG. 10 illustrates an exemplary unmanned aerial vehicle consistent with various embodiments of the present disclosure.

### DETAILED DESCRIPTION OF THE EMBODIMENTS

Reference will now be made in detail to exemplary embodiments of the disclosure, which are illustrated in the accompanying drawings. Wherever possible, the same reference numbers will be used throughout the drawings to refer to the same or like parts.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

An inertial measurement unit (IMU) is used to detect motion information of a movable object. Under the influence of environmental factors, a measurement result of the IMU has a certain drift problem. For example, the IMU can still detect motion information when the IMU is stationary. When the movable object moves, the measurement result of the IMU is ω+Δω=(ω^{x}+Δω^{x}, ω^{y}+Δω^{y}, ω^{z}+Δω^{z}), where ω=(ω^{x}, ω^{y}, ω^{z}) denotes actual motion information of the movable object, and Δω=(Δω^{x}, Δω^{y}, Δω^{z}) denotes a drift value of the measurement result ω+Δω outputted by the IMU. The drift value of IMU is an error of the measurement result outputted by the IMU, that is, a measurement error of the IMU. However, the measurement error of the IMU may change with changing environmental factors. For example, the measurement error of the IMU may change with changing environmental temperature. Usually the IMU is attached to an image sensor. As an operating time of the image sensor increases, the temperature of the image sensor will increase and induce a significant influence on the measurement error of the IMU.

To get the actual motion information ω=(ω^{x}, ω^{y}, ω^{z}) of the movable object, the measurement result outputted by the IMU and the current measurement error of the IMU should be used to calculate ω=(ω^{x}, ω^{y}, ω^{z}). However, the measurement error of the IMU may change with changing environmental factors. The calculated actual motion information of the movable object would be inaccurate if the fixed measurement error of the IMU is used.

The present disclosure provides a drift calibration method and a drift calibration device for an IMU, to at least partially alleviate the above problems.

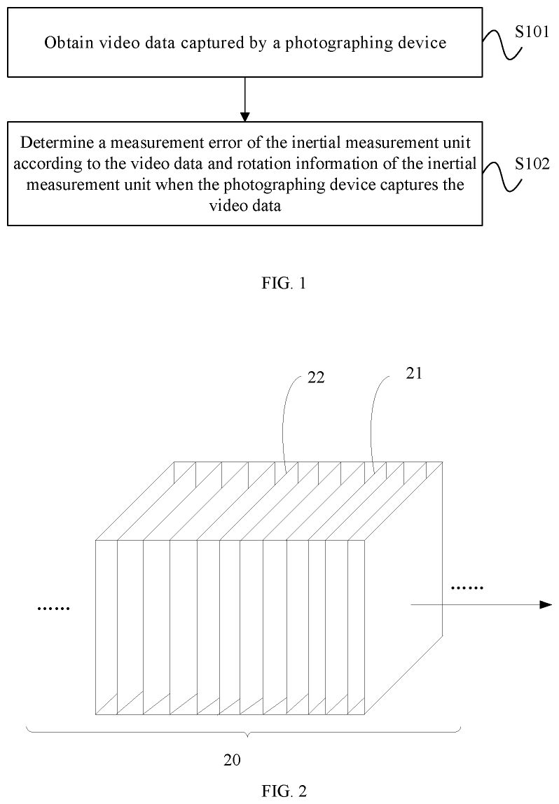

One embodiment of the present disclosure provides a drift calibration method for an IMU. As illustrated in FIG. 1, the method may include:

S101: obtaining video data captured by a photographing device; and

S102: determining a measurement error of the IMU according to the video data and rotary information of the IMU when the photographing device captures the video data.

The drift calibration method of the present disclosure may be used to calibrate a drift value of the IMU, that is, the measurement error of the IMU. The measurement result of the IMU may indicate attitude information of the IMU including at least one of an angular velocity of the IMU, a rotation matrix of the IMU, or a quaternion of the IMU. In some embodiments, the photographing device and the IMU may be disposed at one same printed circuit board (PCB), or the photographing device may be rigidly connected to the IMU.

The photographing device may be a device including a camcorder or a camera. Generally, internal parameters of the photographing device may be determined according to lens parameters of the photographing device. In some other embodiments, the internal parameters of the photographing device may be determined by a calibration method. In one embodiment, internal parameters of the photographing device may be known. The internal parameters of the photographing device may include at least one of a focal length of the photographing device, or pixel size of the photographing device. A relative attitude between the photographing device and the IMU may be a relative rotation relationship between the photographing device and the IMU denoted as [symbol] , and may be already calibrated.

In one embodiment, the photographing device may be a camera, and the internal parameter of the camera may be denoted as g. An image coordinate may be denoted as [x,y]^{T}, and a ray passing through an optical center of the camera may be denoted as [x′,y′,z′]^{T}. Accordingly, from the image coordinate [x,y]^{T} and the internal parameter g of the camera, the ray passing through the optical center of the camera [x′,y′,z′]^{T} may be given by [x′,y′,z′]^{T}=g([x,y]^{T}). Also, from the ray passing through the optical center of the camera [x′,y′,z′]^{T} and the internal parameter g of the camera, the image coordinate [x,y]^{T} may be given by [x,y]^{T}=g⁻¹([x′,y′,z′]^{T}).

In various embodiments of the present disclosure, the photographing device and the IMU may be disposed on an unmanned aerial vehicle, a handheld gimbal, or other mobile devices. The photographing device and the IMU may work at a same time, that is, the IMU may detect its own attitude information and output the measurement result while the photographing device may photograph an object at the same time. For example, the photographing device may photograph a first frame image when the IMU outputs a first measurement result.

In one embodiment, the object may be separated from the photographing device by 3 meters. The photographing device may start photographing the object to get the video data at a time t₁, and may stop photographing at a time t₂. The IMU may start detecting its own attitude information and outputting the measurement result at the time t₁, and may stop detecting its own attitude information and outputting the measurement result at the time t₂. Correspondingly, the video data of the object in a period from t₁ to t₂ may be captured by the photographing device, and the attitude information of the IMU in the period from t₁ to t₂ may be captured by the IMU.

The rotation information of the IMU may include the measurement error of the IMU.

The rotation information of the IMU in the period from t₁ to t₂, that is, the rotation information of the IMU during the period when the photographing device captures the video data, may be determined according to the measurement results output by the IMU in the period from t₁ to t₂. Since the measurement results output by the IMU may include the measurement error of the IMU, the rotation information of the IMU determined according to the measurement results output by the IMU may also include the measurement error of the IMU. The measurement error of the IMU may be determined according to the video data captured by the photographing device in the period from t₁ to t₂ and the rotation information of the IMU in the period from t₁ to t₂.

In one embodiment, the rotation information may include at least one of a rotation angle, a rotation matrix, or a quaternion.

Determining the measurement error of the IMU according to the video data and the rotary information of the IMU when the photographing device captures the video data may include: determining the measurement error of the IMU according to a first image frame and a second image frame separated by a preset number of frames in the video data, and the rotation information of the IMU in a time from a first exposure time of the first image frame to a second exposure time of the second image frame.

The video data captured by the photographing device from the time t₁ to the time t₂ may be denoted as I. The video data I may include a plurality of image frames. A k-th image frame of the video data may be denoted as Iₖ. In one embodiment, a capturing frame rate of the photographing device during the photographing process may be f_{I}, that is, a number of the image frames taken by the photographing device per second during the photographing process may be f_{I}. At the same time, the IMU may collect its own attitude information at a frequency f_{w}, that is, the IMU may output the measurement result at a frequency f_{w}. The measurement result of the IMU may be denoted as ω+Δω=(ω^{x}+Δω^{x}, ω^{y}+Δω^{y}, ω^{z}+Δω^{z}). In one embodiment, f_{w}, may be larger than f_{I}, that is, in the same amount of time, the number of the image frames captured by the photographing device may be smaller than the number of the measurement results outputted by the IMU.

FIG. 2 illustrates an exemplary video data 20 consistent with various embodiments of the present disclosure. In FIG. 2, 21 is one image frame in the video data 20 and 22 is another image frame in the video data. The present disclosure has no limits on the number of image frames in the video data. The IMU may output the measurement result at the frequency f_{w} when the photographing device captures the video data 20. The rotation information of the IMU may be determined according to the measurement result outputted by the IMU when the photographing device captures the video data 20. Further, the measurement error of the IMU may be determined according to the video data 20 and the rotation information of the IMU when the photographing device captures the video data 20.

As illustrated in FIG. 2, the photographing device may photograph the image frame 21 first and then photograph the image frame 22. The image frame 22 may be separated from the first image frame 21 by a preset number of image frames. In one embodiment, determining the measurement error of the IMU according to the video data 20 and the rotation information of the IMU when the photographing device captures the video data 20 may include: determining the measurement error of the IMU according to the image frame 21 and the image frame 22 separated by the preset number of frames in the video data 20, and the rotation information of the IMU in the time from a first exposure time of the image frame 21 to a second exposure time of the image frame 22. The rotation information of the IMU in the time from a first exposure time of the first frame 21 to a second exposure time of the image frame 22 may be determined according to the measurement result of the IMU from the first exposure time to the second exposure time.

In one embodiment, the image frame 21 may be a k-th image frame in the video data 20, and the image frame 22 may be a (k+n)-th image frame in the video data 20 where n≥1, that is, the image frame 21 and the image frame 22 may be separated by (n−1) image frames. The video data 20 may include m image frames where m>n and 1≤k≤m−n. In one embodiment, determining the measurement error of the IMU according to the video data 20 and the rotation information of the IMU when the photographing device captures the video data 20 may include: determining the measurement error of the IMU according to the k-th image frame and the (k+n)-th image frame in the video data 20, and the rotation information of the IMU in the time from an exposure time of the k-th image frame to an exposure time of the (k+n)-th image frame. In one embodiment, k may be varied from 1 to m-n. For example, according to a first image frame and a (1+n)-th image frame of the video data 20, the rotation information of the IMU in the time from an exposure time of the first image frame to an exposure time of the (l+n)-th image frame, a second image frame and a (2+n)-th image frame of the video data 20, the rotation information of the IMU in the time from an exposure time of the second image frame to an exposure time of the (2+n)-th image frame, . . . , a (m-n)-th image frame and a m-th image frame of the video data 20, and the rotation information of the IMU in the time from an exposure time of the (m-n)-th image frame to an exposure time of the m-th image frame, the measurement error of the IMU may be determined.

In one embodiment, determining the measurement error of the IMU according to the first image frame and the second image frame separated by a preset number of frames in the video data, and the rotation information of the IMU in a time from the first exposure time of the first image frame to the second exposure time of the second image frame may include: determining the measurement error of the IMU according to the first image frame and the second image frame adjacent to the first image frame in the video data, and the rotation information of the IMU in a time from a first exposure time of the first image frame to a second exposure time of the second image frame.

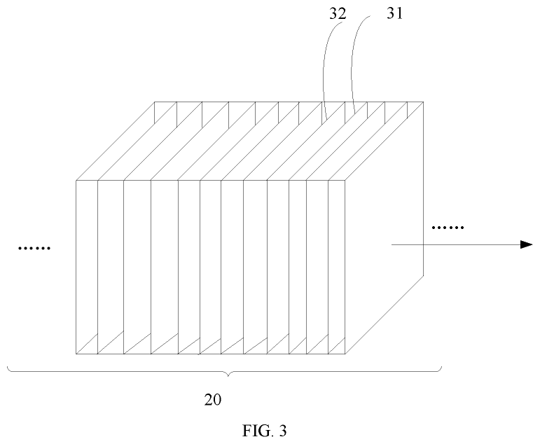

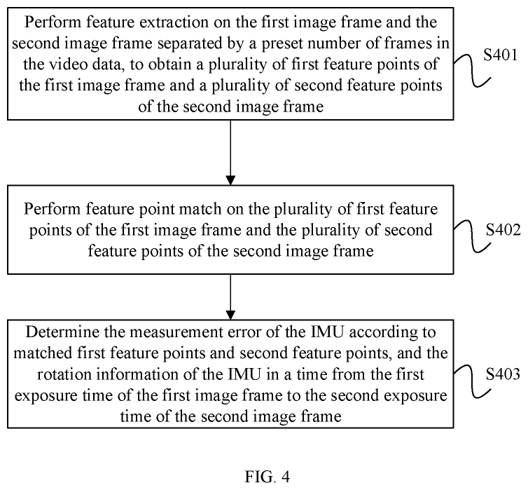

In the video data, the first image frame and the second image frame separated by a preset number of frames in the video data may be the first image frame and the second image frame adjacent to the first image frame in the video data. For example, in the video data 20, the image frame 21 and the image frame 22 may be separated by (n−1) image frames. When n=1, the image frame 21 may be a k-th image frame in the video data 20, and the image frame 22 may be a (k+1)-th image frame in the video data 20, that is, the image frame 21 and the image frame 22 may be adjacent to each other. As illustrated in FIG. 3, an image frame 31 and an image frame 32 may be two image frames adjacent to each other. Correspondingly, determining the measurement error of the IMU according to the image frame 21 and the image frame 22 separated by the preset number of frames in the video data 20, and the rotation information of the IMU in the time from a first exposure time of the image frame 21 to a second exposure time of the image frame 22 may include: determining the measurement error of the IMU according to the image frame 31 and the image frame 32 adjacent to the image frame 31 in the video data 20, and the rotation information of the IMU in the time from a first exposure time of the image frame 31 to a second exposure time of the image frame 32. Since the IMU may output the measurement result at a frequency larger than the capturing frame frequency at which the photographing device collects the image information, the IMU may output a plurality of measurement results during the exposure time of two adjacent image frames. The rotation information of the IMU in the time from the first exposure time of the image frame 31 to the second exposure time of the image frame 32 may be determined according to the plurality of measurement results outputted by the IMU.

In one embodiment, the image frame 31 may be a k-th image frame in the video data 20, and the image frame 32 may be a (k+1)-th image frame in the video data 20, that is, the image frame 31 and the image frame 32 may be adjacent to each other. The video data 20 may include m image frames where m>n and 1≤k≤m−1. In one embodiment, determining the measurement error of the IMU according to the video data 20 and the rotation information of the IMU when the photographing device captures the video data 20 may include: determining the measurement error of the IMU according to the k-th image frame and the (k+1)-th image frame in the video data 20, and the rotation information of the IMU in the time from an exposure time of the k-th image frame to an exposure time of the (k+1)-th image frame. In one embodiment, 1≤k≤m−1, that is, k may be varied from 1 to m−1. For example, according to a first image frame and a second image frame of the video data 20, the rotation information of the IMU in the time from an exposure time of the first image frame to an exposure time of the second image frame, a second image frame and a third image frame of the video data 20, the rotation information of the IMU in the time from an exposure time of the second image frame to an exposure time of the third image frame, . . . , a (m−1)-th image frame and a m-th image frame of the video data 20, and the rotation information of the IMU in the time from an exposure time of the (m−1)-th image frame to an exposure time of the m-th image frame, the measurement error of the IMU may be determined.

In another embodiment, determining the measurement error of the IMU according to the first image frame and the second image frame separated by a preset number of frames in the video data, and the rotation information of the IMU in a time from the first exposure time of the first image frame to the second exposure time of the second image frame may include:

S401: performing feature extraction on the first image frame and the second image frame separated by a preset number of frames in the video data, to obtain a plurality of first feature points of the first image frame and a plurality of second feature points of the second image frame;

S402: performing feature point match on the plurality of first feature points of the first image frame and the plurality of second feature points of the second image frame; and

S403: determining the measurement error of the IMU according to matched first feature points and second feature points, and the rotation information of the IMU in a time from the first exposure time of the first image frame to the second exposure time of the second image frame.

As illustrated in FIG. 2, the image frame 21 may be a k-th image frame in the video data 20, and the image frame 22 may be a (k+n)-th image frame in the video data 20 where that is, the image frame 21 and the image frame 22 may be separated by (n−1) image frames. The present disclosure has no limits on the number of image frames separating the image frame 21 from the image frame 22 and a value of (n−1). The image frame 21 may be denoted as the first image frame, and the image frame 22 may be denoted as the second image frame. The video data 20 may include multiple pairs of the first image frame and the second frame image separated by the preset number of image frames.

In one embodiment, m may be 1. As illustrated in FIG. 3, the image frame 31 may be a k-th image frame in the video data 20, and the image frame 32 may be a (k+1)-th image frame in the video data 20, that is, the image frame 31 and the image frame 32 may be adjacent to each other. The image frame 31 may be denoted as the first image frame, and the image frame 32 may be denoted as the second image frame. The video data 20 may include multiple pairs of the first image frame and the second frame image adjacent to each other.

Feature extraction may be performed on each pair of the first image frame and the second image frame adjacent to each other by using a feature detection method, to obtain the first plurality of first feature points of the first image frame and the plurality of second feature points of the second image frame. The feature detection method may include at least one of a SIRF algorithm (scale-invariant feature transform algorithm), a SURF algorithm, an ORB algorithm, or a Haar corner point algorithm. An i-th feature point of a k-th image frame may be D_{k,i}, D_{k,i}=(S_{k,i},[x_{k,i},y_{k,i}]), where i may have one or more values, S_{k,i} may be a descriptor of the i-th feature point of the k-th image frame. A descriptor may include at least one of a SIFT descriptor, a SIFT descriptor, an ORB descriptor, or an LBP descriptor. [x_{k,i},y_{k,i}] may be a position (that is, a coordinator) of the i-th feature point of the k-th image frame in the k-th image frame. Similarly, An i-th feature point of a (k+1)-th image frame may be D_{k+1,i},D_{k+1,i}=(S_{k+1,i},[x_{k+1,i},y_{k+1,i}]). The present disclosure has no limits on a number of the feature points of the k-th image frame and on a number of the feature points of the (k+1)-th image frame.

In one embodiment, S402 may include performing feature point match on the plurality of first feature points of the k-th image frame and the plurality of second feature points of the (k+1)-th image frame. After matching the feature points and excluding error match points, feature point pairs matching the k-th image frame and the (k+1)-th image frame in a one-to-one relationship may be obtained. For example, an i-th feature point D_{k,i} of the k-th image frame may match with the i-th feature point D_{k+1,i} of the (k+1)-th image frame, and a match relationship between these two feature points may be denoted as Pₖⁱ=(D_{k,i},D_{k+1,i}). In various embodiments, i may have one or more values.

The video data 20 may include a plurality of pairs of the first image frame and the second image frame adjacent to each other, and the first image frame and the second image frame adjacent to each other may have more than one pair of matched feature points. As illustrated in FIG. 3, the image frame 31 may be a k-th image frame in the video data 20, and the image frame 32 may be a (k+1)-th image frame in the video data 20. The exposure time of the k-th image frame may be tₖ, and the exposure time of the (k+1)-th image frame may be tₖ₊₁. The IMU may output a plurality of measurement results from the exposure time tₖ of the k-th image frame and the exposure time tₖ₊₁ of the (k+1)-th image frame. According to the plurality of measurement result outputted by the IMU from the exposure time tₖ of the k-th image frame and the exposure time tₖ₊₁ of the (k+1)-th image frame, the rotation information of the IMU between tₖ and tₖ₊₁ may be determined. Further, according to the pairs of matched feature points, and the rotation information of the IMU between tₖ and tₖ₊₁, the measurement error of the IMU may be determined.

In some embodiments, the photographing device may include a camera module. Based on different sensors in different camera modules, different ways may be used to determine an exposure time of an image frame, and the rotation information of the IMU from the first exposure time of the first image frame to the second exposure time of the second image frame.

In one embodiment, the camera module may use a global shutter sensor, and different rows in an image frame may be exposed simultaneously. A number of image frames captured by the camera module when the camera module is photographing the video data may be f_{I}, that is, a time for the camera module to capture an image frame may be 1/f_{I}. Accordingly, the exposure time of the k-th image frame may be k/f_{I}, that is, tₖ=k/f_{I}. The exposure time of the (k+1)-th image frame may be tₖ₊₁=(k+1)/f_{I}. In the time period[tₖ,tₖ₊₁] the IMU may collect the attitude information of the IMU at a frequency f_{w}. The attitude information of the IMU may include at least one of an angular velocity of the IMU, a rotation matrix of the IMU, or a quaternion of the IMU. The rotation information of the IMU may include at least one of a rotation angular, a rotation matrix, or a quaternion. When the measurement result of the IMU is the angular velocity of the IMU, the rotation angle of the IMU in the time period [tₖ,tₖ₊₁] may be obtained by integrating the angular velocity of the IMU in the time period [tₖ,tₖ₊₁]. When the measurement result of the IMU is the rotation matrix of the IMU, the rotation matrix of the IMU in the time period [tₖ,tₖ₊₁] may be obtained by chain multiplying and integrating the rotation matrix of the IMU during the time period [tₖ, tₖ₊₁]. When the measurement result of the IMU is the quaternion of the IMU, the quaternion of the IMU in the time period [tₖ,tₖ₊₁] may be obtained by chain multiplying and integrating the quaternion of the IMU during the time period [tₖ,tₖ₊₁]. For description purposes only, one embodiment where the measurement result of the IMU is the rotation matrix of the IMU and the rotation matrix of the IMU in the time period [tₖ,tₖ₊₁] is obtained by chain multiplying and integrating the rotation matrix of the IMU during the time period [tₖ,tₖ₊₁] will be used as an example to illustrate the present disclosure. The rotation matrix of the IMU in the time period [tₖ,tₖ₊₁] may be denoted as R_{k,k+1}(Δω).

In another embodiment, the camera module may use a rolling shutter sensor and different rows in an image frame may be exposed at different times. In an image frame, the time from the exposure of the first row to the exposure of the last row may be T, and a height of the image frame may be H. For the rolling shutter sensor, an exposure time of a feature point may be related to a position of the feature point in the image frame. An i-th feature point D_{k,i} of the k-th image frame may be located at a position [x_{k,i},y_{k,i}] in the k-th image frame, When considering the k-th image frame as a matrix, x_{k,i} may be a coordinate of the i-th feature point in a width direction of the image, and y_{k,i} may be a coordinate of the i-th feature point in a height direction of the image. Correspondingly, D_{k,i} may be located in a y_{k,i} row of the image frame and the exposure time of D_{k,i} may be t_{k,i} and

$${t}_{k , i} = \frac{k}{{f}_{I}} + \frac{{y}_{k , i}}{H} T .$$

Similarly, a feature point D_{k+1,i} matching D_{k,i} may be t_{k+1,i} and

$${t}_{k + 1 , i} = \frac{k + 1}{{f}_{I}} + \frac{{y}_{k + 1 , i}}{H} T .$$

In this period, the IMU may capture the attitude information of the IMU at a frequency of f_{w}. The attitude information of the IMU may include at least one of an angular velocity of the IMU, a rotation matrix of the IMU, or a quaternion of the IMU. The rotation information of the IMU may include at least one of a rotation angular, a rotation matrix, or a quaternion. When the measurement result of the IMU is the angular velocity of the IMU, the rotation angle of the IMU in the time period [tₖ,tₖ₊₁] may be obtained by integrating the angular velocity of the IMU in the time period [tₖ, tₖ₊₁]. When the measurement result of the IMU is the rotation matrix of the IMU, the rotation matrix of the IMU in the time period [tₖ,tₖ₊₁] may be obtained by chain multiplying and integrating the rotation matrix of the IMU during the time period [tₖ,tₖ₊₁]. When the measurement result of the IMU is the quaternion of the IMU, the rotation matrix of the IMU in the time period [tₖ,tₖ₊₁] may be obtained by chain multiplying and integrating the quaternion of the IMU during the time period [tₖ,tₖ₊₁]. For description purposes only, one embodiment where the measurement result of the IMU is the rotation matrix of the IMU and the rotation matrix of the IMU in the time period [tₖ,tₖ₊₁] is obtained by chain multiplying and integrating the rotation matrix of the IMU during the time period [tₖ,tₖ₊₁] will be used as an example to illustrate the present disclosure. The rotation matrix of the IMU in the time period [tₖ,tₖ₊₁] may be denoted as R_{k,k+1}ⁱ(Δω).

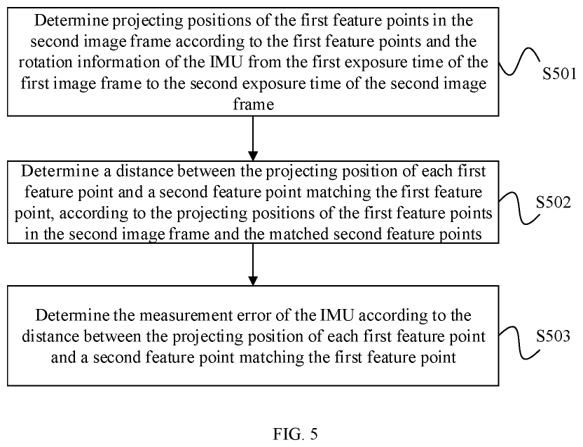

As illustrated in FIG. 5, determining the measurement error of the IMU according to matched first feature points and second feature points, and the rotation information of the IMU in a time from the first exposure time of the first image frame to the second exposure time of the second image frame, may include:

S501: determining projecting positions of the first feature points onto the second image frame according to the first feature points and the rotation information of the IMU from the first exposure time of the first image frame to the second exposure time of the second image frame;

S502: determining a distance between the projecting position of each first feature point and a second feature point matching with the first feature point, according to the projecting positions of the first feature points onto the second image frame and the matched second feature points; and

S503: determining the measurement error of the IMU according to the distance between the projecting position of each first feature point and a second feature point matching with the first feature point.

The i-th feature point in the k-th image frame may match the i-th feature point D_{k+1,i} in the (k+1)-th image frame. The i-th feature point in the k-th image frame may be denoted as a first feature point, and the i-th feature point D_{k+1,i} in the (k+1)-th image frame may be denoted as a second feature point. When the camera module uses the global shutter sensor, the be rotation matrix of the IMU in the time period [tₖ,tₖ₊₁] may be denoted as R_{k,k+1}(Δω). When the camera module uses the rolling shutter sensor, the rotation matrix of the IMU in the time period [t_{k,i},t_{k+1,i}] may be denoted as R_{k,k+1}ⁱ(Δω). According to the i-th feature point D_{k,i} in the k-th image frame and the rotation matrix R_{k,k+1}ⁱ(Δω) of the IMU in the time period [tₖ,tₖ₊₁], the projecting position of the i-th feature point D_{k,i} of the k-th image frame onto the (k+1)-th image frame.

In one embodiment, determining the projecting positions of the first feature points onto the second image frame according to the first feature points and the rotation information of the IMU from the first exposure time of the first image frame to the second exposure time of the second image frame may include: determining the projecting positions of the first feature points onto the second image frame according to the positions of the first feature points in the first image frame, the rotation information of the IMU from the first exposure time of the first image frame to the second exposure time of the second image frame, a relative attitude between the photographing device and the IMU, and the internal parameter of the photographing device.

The relative attitude between the photographing device and the IMU may be denoted as [symbol] . In one embodiment, the relative attitude between the photographing device and the IMU [symbol] may be a rotation relationship of a coordinate system of the camera module with respect to a coordinate system of the IMU, and may be known.

When the camera muddle uses the global shutter sensor, the i-th feature point D_{k,i} of the k-th image frame may be located at a position [x_{k,i},y_{k,i}] in the k-th image frame. The exposure time of the k-th image frame may be tₖ=k/f_{I}, and the exposure time of the (k+1)-th image frame may be tₖ₊₁=(k+1)/f_{I}. The rotation matrix of the IMU in the time period [tₖ, tₖ₊₁] may be denoted as R_{k,k+1}(Δω). The relative attitude between the photographing device and the IMU may be denoted as [symbol] , and the internal parameter of the photographing device may be denoted as g. Correspondingly, according to the imaging principle of the camera, the projecting position of the i-th feature point D_{k,i} of the k-th image frame onto the (k+1)-th image frame may be

g⁻¹( [symbol] R_{k,k+1}(Δω)g([x_{k,i},y_{k,i}]^{T})) (1).

When the camera module uses the rolling shutter sensor, the i-th feature point D_{k,i} of the k-th image frame may be located at a position [x_{k,i}y_{k,i}] in the k-th image frame. The exposure time of D_{k,i} may be t_{k,i} and

$${t}_{k , i} = \frac{k}{{f}_{I}} + \frac{{y}_{k , i}}{H} T ,$$

and the exposure time of the feature point D_{k+1,i} matching with D_{k,i} may be t_{k±1,i} and

$${t}_{k + 1 , i} = \frac{k + 1}{{f}_{I}} + \frac{{y}_{k + 1 , i}}{H} T .$$

The rotation matrix of the IMU in the time period [t_{k,i},t_{k+1,i}] may be denoted as R_{k,k+1}ⁱ(Δω). The relative attitude between the photographing device and the IMU may be denoted as [symbol] , and the internal parameter of the photographing device may be denoted as g. Correspondingly, according to the imaging principle of the camera, the projecting position of the i-th feature point D_{k,i} of the k-th image frame onto the (k+1)-th image frame may be

g⁻¹( [symbol] Rⁱ_{k,k+1}(Δω)g([x_{k,i},y_{k,i}]^{T})) (2).

In various embodiment, the internal parameter of the photographing device may include at least one of a focal length of the photographing device, or a pixel size of the photographing device.

In one embodiment, the relative attitude between the photographing device and the IMU [symbol] may be known, while Δω and R_{k,k+1}(Δω) may be unknown. When the camera module uses the global shutter sensor and a correct Δω is given,

[x_{k+1,i},y_{k+1,i}]^{T}=g⁻¹( [symbol] R_{k,k+1}(Δω)g([x_{k,i},y_{k,i}]^{T}) (3).

When the camera module uses the rolling shutter sensor and a correct Δω is given,

[x_{k+1,i},y_{k+1,i}]^{T}=g⁻¹( [symbol] R_{k,k+1}ⁱ(Δω)g([x_{k,i},y_{k,i}]^{T})) (4).

If the IMU has no measurement error, that is, Δω=0, the projecting position of the i-th feature point D_{k,i} of the k-th image frame onto the (k+1)-th image frame may coincide with the feature point D_{k+1,i} in the (k+1)-th image frame that matches D_{k,i}. That is, when Δω=0, the distance between the projecting position of the i-th feature point D_{k,i} of the k-th image frame onto the (k+1)-th image frame and the feature point D_{k+1,i} of the (k+1)-th image frame that matches with D_{k,i} may be 0.

In actual situations, the IMU has the measurement error, that is, Δω #0 and keeps changing. Δω may have to be determined. When Δω is not determined and the camera module uses the global shutter sensor, the distance between the projecting position of the i-th feature point D_{k,i} of the k-th image frame onto the (k+1)-th image frame and the feature point D_{k+1,i} of the (k+1)-th image frame that matches with D_{k,i} may be

d([x_{k+1,i},y_{k+1,i}]^{T},g⁻¹( [symbol] R_{k,k+1}(Δω)g([x_{k,i},y_{k,i}]^{T}))) (5).

When Δω is not determined and the camera module uses the rolling shutter sensor, the distance between the projecting position of the i-th feature point D_{k,i} of the k-th image frame onto the (k+1)-th image frame and the feature point D_{k+1,i} of the (k+1)-th image frame that matches with D_{k,i} may be

d([x_{k+1,i},y_{k+1,i}]^{T},g⁻¹( [symbol] R_{k,k+1}ⁱ(Δω)g([x_{k,i},y_{k,i}]^{T}))) (6).

In various embodiments, the distance may include at least one of a Euclidean distance, an urban distance, or a Mahalanobis distance. For example, the distance d in Equation (5) and Equation (6) may be one or more of the Euclidean distance, an urban distance, or a Mahalanobis distance.

In one embodiment, determining the measurement error of the IMU according to the distance between the projecting position of each first feature point and a second feature point matching with the first feature point, may include: optimizing the distance between the projecting position of each first feature point and a second feature point matching with the first feature point to determine the measurement error of the IMU.

In Equation (5), the measurement error Δω may be unknown and need to be resolved. When Δω=0 the distance between the projecting position of the i-th feature point D_{k,i} of the k-th image frame onto the (k+1)-th image frame and the feature point D_{k+1,i} of the (k+1)-th image frame that matches with D_{k,i} may be 0, that is the distance d in Equation (5) may be 0. Whereas, if a value of Δω can be found to minimize the distance d between the projecting position of the i-th feature point D_{k,i} of the k-th image frame onto the (k+1)-th image frame and the feature point D_{k+1,i} of the (k+1)-th image frame that matches with D_{k,i} in Equation (5) such as 0, the value of Δω that minimizes the distance d may be used as a solution of Δω.

In Equation (6), the measurement error Δω may be unknown and need to be resolved. When Δω=0 the distance between the projecting position of the i-th feature point D_{k,i} of the k-th image frame onto the (k+1)-th image frame and the feature point D_{k+1,i} of the (k+1)-th image frame that matches with D_{k,i} may be 0, that is, the distance d in Equation (6) may be 0. Whereas, if a value of Δω can be found to minimize the distance between the projecting position of the i-th feature point D_{k,i} of the k-th image frame onto the (k+1)-th image frame and the feature point D_{k+1,i} of the (k+1)-th image frame that matches with D_{k,i} in Equation (6), for example, d=0, the value of Δω that minimizes the distance d may be used as a solution of Δω.

In one embodiment, optimizing the distance between the projecting position of each first feature point and a second feature point matching with the first feature point to determine the measurement error of the IMU, may include: minimizing the projecting position of each first feature point and a second feature point matching with the first feature point to determine the measurement error of the IMU.

In one embodiment, Equation (5) may be optimized to get a value of the measurement error Δω of the IMU that minimizes the distance d, to determine the measurement error Δω of the IMU. In another embodiment, Equation (6) may be optimized to get a value of the measurement error Δω of the IMU that minimizes the distance d, to determine the measurement error Δω of the IMU.

The video data 20 may include a plurality of pairs of the first image frame and the second image frame adjacent to each other, and the first image frame and the second image frame adjacent to each other may have one or more pairs of the matched feature points. When the camera module uses the global shutter sensor, the measurement error Δω of the IMU may be given by:

Δ\hat{ }Ω=arg min_{Δω}ΣₖΣᵢd([x_{k+1,i},y_{k+1,i}]^{T},g⁻¹( [symbol] R_{k,k+1}(Δω)g([x_{k,i},y_{k,i}]^{T}))) (7);

and when the camera module uses the rolling shutter sensor, the measurement error Δω of the IMU may be given by:

Δ\hat{ }ω=arg min_{Δω}ΣₖΣᵢd([x_{k+1,i},y_{k+1,i}]^{T},g⁻¹( [symbol] R_{k,k+1}ⁱ(Δω)g([x_{k,i},y_{k,i}]^{T}))) (8);

where k indicates the k-th image frame in the video data and i indicates the i-th feature point.

Equation (7) may have a plurality of equivalent forms including but not limit to:

$$\begin{matrix}\hat{Δω} = arg {min}_{Δ ω} {\sum }_{k} {\sum }_{i} d ( g ( {[ {x}_{k + 1 , i} , {y}_{k + 1 , i} ]}^{T} ) , ℛ {R}_{k , k + 1} ( Δ ω ) g ( {[ {x}_{k , i} , {y}_{k , i} ]}^{T} ) ) ; & ( 9 ) \\ \hat{Δω} = arg {min}_{Δ ω} {\sum }_{k} {\sum }_{i} d ( {ℛ}^{- 1} g ( {[ {x}_{k + 1 , i} , {y}_{k + 1 , i} ]}^{T} ) , {R}_{k , k + 1} ( Δ ω ) g ( {[ {x}_{k , i} , {y}_{k , i} ]}^{T} ) ) ; & ( 10 ) \\ \hat{Δω} = arg {min}_{Δ ω} {\sum }_{k} {\sum }_{i} d ( {R}_{k , k + 1}^{- 1} ( Δ ω ) {ℛ}^{- 1} g ( {[ {x}_{k + 1 , i} , {y}_{k + 1 , i} ]}^{T} ) , g ( {[ {x}_{k , i} , {y}_{k , i} ]}^{T} ) ) . & ( 11 )\end{matrix}$$

Equation (8) may have a plurality of equivalent forms including but not limit to:

$$\begin{matrix}\hat{Δω} = arg {min}_{Δ ω} {\sum }_{k} {\sum }_{i} d ( g ( {[ {x}_{k + 1 , i} , {y}_{k + 1 , i} ]}^{T} ) , ℛ {R}_{k , k + 1}^{i} ( Δ ω ) g ( {[ {x}_{k , i} , {y}_{k , i} ]}^{T} ) ) ; & ( 12 ) \\ \hat{Δω} = arg {min}_{Δ ω} {\sum }_{k} {\sum }_{i} d ( {ℛ}^{- 1} g ( {[ {x}_{k + 1 , i} , {y}_{k + 1 , i} ]}^{T} ) , {R}_{k , k + 1}^{i} ( Δ ω ) g ( {[ {x}_{k , i} , {y}_{k , i} ]}^{T} ) ) ; & ( 13 ) \\ \hat{Δω} = arg {min}_{Δ ω} {\sum }_{k} {\sum }_{i} d ( {( {R}_{k , k + 1}^{i} ( Δω ) )}^{- 1} {ℛ}^{- 1} g ( {[ {x}_{k + 1 , i} , {y}_{k + 1 , i} ]}^{T} ) , g ( {[ {x}_{k , i} , {y}_{k , i} ]}^{T} ) ) . & ( 14 )\end{matrix}$$

In the present disclosure, when the photographing device captures the video data, the rotation information of the IMU during the photographing device captures the video data may be determined. The rotation information of the IMU may include the measurement error of the IMU. Since the video data and the measurement result of the IMU can be obtained accurately, the determined measurement error of the IMU according to the video data and the rotation information of the IMU may be accurate, and a computing accuracy of the moving information of the movable object may be improved.

In one embodiment, after determining the measurement error of the IMU according to e video data and the rotation information of the IMU during the photographing device captures the video data, the method may further include: calibrating the measurement result of the IMU according to the measurement error of the IMU.

For example, the measurement result ω+Δω of the IMU may not accurately reflect the actual moving information of the movable object detected by the IMU. Correspondingly, after determining the measurement error Δω of the IMU, the measurement result ω+Δω of the IMU may be calibrated according to the measurement error Δω of the IMU. For example, the accurate measurement result ω of the IMU may be obtained by subtracting the measurement error Δω of the IMU from the measurement result ω+Δω of the IMU. The accurate measurement result ω of the IMU may reflect the actual moving information of the movable object detected by the IMU accurately, and a measurement accuracy of the IMU may be improved.

In some other embodiments, the measurement error of the IMU may be determined online in real time. That is, the measurement error Δω of the IMU may be determined online in real time when the environmental factors in which the IMU is located change. Correspondingly, the determined measurement error Δω of the IMU may change with the changing environmental factors in which the IMU is located, to avoid using the fixed measurement error Δω of the IMU to calibrate the measurement result ω+Δω of the IMU, and the measurement accuracy of the IMU may be improved further.

In one embodiment, the IMU may be attached to the image sensor. As the image sensor's working time increases, the temperature of the image sensor may increase, and the temperature of the image sensor may have a significant effect on the measurement error of the IMU. The measurement error Δω of the IMU may be determined online in real time when the environmental factors in which the IMU is located change. Correspondingly, the determined measurement error Δω of the IMU may change with the changing temperature of the image sensor, to avoid using the fixed measurement error Δω of the IMU to calibrate the measurement result ω+Δω of the IMU, and the measurement accuracy of the IMU may be improved further.

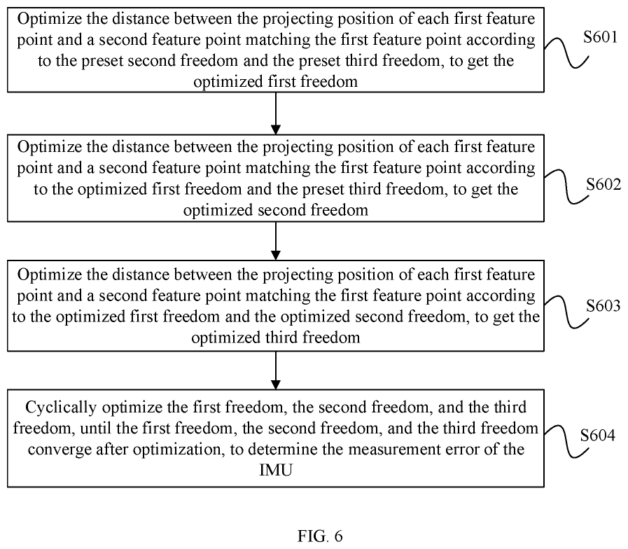

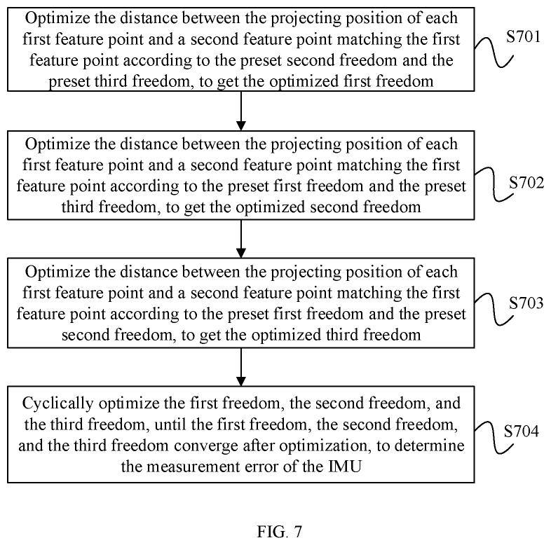

The present disclosure also provides another drift calibration method of the IMU. FIG. 6 illustrates another exemplary drift calibration method for an inertial measurement unit provided by another embodiment of the present disclosure; and FIG. 7 illustrates another exemplary drift calibration method for an inertial measurement unit provided by another embodiment of the present disclosure. Based on the embodiment illustrated in FIG. 1, the measurement error of the IMU may include a first degree of freedom, a second degree of freedom, and a third degree of freedom. For example, the measurement error Δω of the IMU may include a first degree of freedom Δω^{x}, a second degree of freedom Δω^{y}, and a third degree of freedom Δω^{z}, that is, Δω=(Δω^{x},Δω^{y},Δω^{z}). By substituting Δω=(Δω^{x}, Δω^{y}, Δω^{z}) into any one of Equation (7)-Equation (14), a transformed equation may be derived. For example, by substituting Δω=(Δω^{x}, Δω^{y}, Δω^{z}) into Equation (8), Equation (15) in the following may be derived:

Δ\hat{ }ω=arg min_{Δω}_{^{x}}_{,Δω}_{^{y}}_{,Δω}_{^{z}}ΣₖΣᵢd([x_{k+1,i},y_{k+1,i}]^{T},g⁻¹( [symbol] R_{k,k+1}ⁱ(Δω^{x},Δω^{y},Δω^{z})g([x_{k,i},y_{k,i}]^{T}))) (15).

Equation (15) may be transformed further to:

Δ\hat{ }ω=arg min_{Δω}_{^{x}} min_{Δω}_{^{y}} min_{Δω}_{^{z}}ΣₖΣᵢd([x_{k+1,i},y_{k+1,i}]^{T},g⁻¹( [symbol] R_{k,k+1}ⁱ(Δω^{x},Δω^{y},Δω^{z})g([x_{k,i},y_{k,i}]^{T}))) (16).

In one embodiment, as illustrated in FIG. 6, optimizing the distance between the projecting position of each first feature point and a second feature point matching with the first feature point to determine the measurement error of the IMU, may include:

S601: optimizing the distance between the projecting position of each first feature point and a second feature point matching with the first feature point according to the preset second degree of freedom and the preset third degree of freedom, to get the optimized first degree of freedom;

S602: optimizing the distance between the projecting position of each first feature point and a second feature point matching with the first feature point according to the optimized first degree of freedom and the preset third degree of freedom, to get the optimized second degree of freedom;

S603: optimizing the distance between the projecting position of each first feature point and a second feature point matching with the first feature point according to the optimized first degree of freedom and the optimized second degree of freedom, to get the optimized third degree of freedom; and

S604: cyclically optimizing the first degree of freedom, the second degree of freedom, and the third degree of freedom, until the first degree of freedom, the second degree of freedom, and the third degree of freedom converge after optimization, to determine the measurement error of the IMU.

In Equation (16), [x_{k,i},y_{k,i}]^{T}, and g may be known, while (Δω^{x},Δω^{y},Δω^{z}) may be unknown. The present disclosure may resolve the first degree of freedom Δω^{x}, the second degree of freedom Δω^{y}, and the third degree of freedom Δω^{z} to determine Δω=(Δω^{x},Δω^{y},Δω^{z}). Initial values of the first degree of freedom Δω^{x}, the second degree of freedom Δω^{y}, and the third degree of freedom Δω^{z} may be preset. In one embodiment, the initial value of the first degree of freedom Δω^{x} may be Δω₀^{x}, the initial value of the second degree of freedom Δω^{y} may be Δω₀^{y}, and the initial value of the third degree of freedom Δω^{z} may be Δω₀^{z}.

In S601, Equation (16) may be resolved according to the preset second degree of freedom Δω₀^{y} and the preset third degree of freedom Δω₀^{z}, to get the optimized first degree of freedom Δω₁^{x}. That is, Equation (16) may be resolved according to the initial value of the second degree of freedom Δω^{y} and the initial value of the third degree of freedom Δω^{z}, to get the optimized first degree of freedom Δω₁^{x}.

In S602, Equation (16) may be resolved according to the optimized first degree of freedom Δω₁^{x} in S601 and the preset third degree of freedom Δω₀^{z} that is the initial value of the third degree of freedom Δω^{z}, to get the optimized second degree of freedom Δω₁^{y}.

In S603, Equation (16) may be resolved according to the optimized first degree of freedom Δω₁^{x} in S601 and the optimized second degree of freedom Δω₁^{y} in S602, to get the optimized third degree of freedom Δω₁^{z}.

The optimized first degree of freedom Δω₁^{x}, the optimized second degree of freedom Δω₁^{y}, and the optimized third degree of freedom Δω₁^{z} may be determined through S601-S603 respectively. Further, S601 may be performed again, and Equation (16) may be resolved again according to the optimized second degree of freedom Δω₁^{y} and the optimized third degree of freedom Δω₁^{z}, to get the optimized first degree of freedom Δω₂^{x}. S602 then may be performed again, and Equation (16) may be resolved again according to the optimized first degree of freedom Δω₂^{x} and the optimized third degree of freedom Δω₁^{z}, to get the optimized second degree of freedom Δω₂^{y}. Then S603 may be performed again, and Equation (16) may be resolved again according to the optimized first degree of freedom Δω₂^{x} and the optimized second degree of freedom Δω₂^{y}, to get the optimized third degree of freedom Δω₂^{z}. After every cycle that S601-S603 are performed once, the optimized first degree of freedom, the optimized second degree of freedom, and the optimized third degree of freedom may be updated once. As a number of the cycles of S601-S603 increases, the optimized first degree of freedom, the optimized second degree of freedom, and the optimized third degree of freedom may converge gradually. In one embodiment, the steps of S601-S603 may be performed continuously until the optimized first degree of freedom, the optimized second degree of freedom, and the optimized third degree of freedom converge. The optimized first degree of freedom, the optimized second degree of freedom, and the optimized third degree of freedom after converging, may be used as the first degree of freedom Δω^{x}, the second degree of freedom Δω^{y}, and the third degree of freedom Δω^{z} of the finally required by the present embodiment. Then according to the optimized first degree of freedom, the optimized second degree of freedom, and the optimized third degree of freedom after converging, the solution of the measurement error of the IMU may be determined, which may be denoted as (Δω^{x},Δω^{y},Δω^{z}).

In another embodiment, as illustrated in FIG. 7, optimizing the distance between the projecting position of each first feature point and a second feature point matching with the first feature point to determine the measurement error of the IMU, may include:

S701: optimizing the distance between the projecting position of each first feature point and a second feature point matching with the first feature point according to the preset second degree of freedom and the preset third degree of freedom, to get the optimized first degree of freedom;

S702: optimizing the distance between the projecting position of each first feature point and a second feature point matching with the first feature point according to the preset first degree of freedom and the preset third degree of freedom, to get the optimized second degree of freedom;

S703: optimizing the distance between the projecting position of each first feature point and a second feature point matching with the first feature point according to the preset first degree of freedom and the preset second degree of freedom, to get the optimized third degree of freedom; and

S704: cyclically optimizing the first degree of freedom, the second degree of freedom, and the third degree of freedom, until the first degree of freedom, the second degree of freedom, and the third degree of freedom converge after optimization, to determine the measurement error of the IMU.

In Equation (16), [x_{k,i},y_{k,i}]^{T}, [symbol] , and g may be known, while (Δω^{x},Δω^{y},Δω^{z}) may be unknown. The present disclosure may resolve the first degree of freedom Δω^{x}, the second degree of freedom Δω^{y}, and the third degree of freedom Δω^{z} to determine Δω=(Δω^{x},Δω^{y},Δω^{z}). An initial value of the first degree of freedom Δω^{x}, the second degree of freedom Δω^{y}, and the third degree of freedom Δω^{z} may be preset. In one embodiment, the initial value of the first degree of freedom Δω^{x} may be Δω₀^{x}, the initial value of the second degree of freedom Δω^{y} may be Δω₀^{y}, and the initial value of the third degree of freedom Δω^{z} may be Δω₀^{z}.

In S701, Equation (16) may be resolved according to the preset second degree of freedom Δω₀^{y} and the preset third degree of freedom Δω₀^{z}, to get the optimized first degree of freedom Δω₁^{x}. That is, Equation (16) may be resolved according to the initial value of the second degree of freedom Δω^{y} and the initial value of the third degree of freedom Δω^{z}, to get the optimized first degree of freedom Δω₁^{x}.

In S702, Equation (16) may be resolved according to the preset first degree of freedom Δω₀^{x} and the preset third degree of freedom Δω₀^{z} to get the optimized second degree of freedom Δω₁^{y}. That is, Equation (16) may be resolved according to the initial value of the first degree of freedom Δω^{x} and the initial value of the third degree of freedom Δω^{z}, to get the optimized second degree of freedom Δω₁^{y}.

In S703, Equation (16) may be resolved according to the preset first degree of freedom Δω₀^{x} and the preset second degree of freedom Δω₀^{y}, to get the optimized third degree of freedom Δω₁^{z}. That is, Equation (16) may be resolved according to the initial value of the first degree of freedom Δω^{x} and the initial value of the second degree of freedom Δω₁^{y}, to get the optimized third degree of freedom Δω₁^{z}.

The optimized first degree of freedom Δω₁^{x}, the optimized second degree of freedom Δω₁^{y}, and the optimized third degree of freedom Δω₁^{z} may be determined through S701-S703 respectively. Further, S701 may be performed again, and Equation (16) may be resolved again according to the optimized second degree of freedom Δω₁^{z} and the optimized third degree of freedom Δω₁^{z}, to get the optimized first degree of freedom Δω₂^{x}. S702 then may be performed again, and Equation (16) may be resolved again according to the optimized first degree of freedom Δω₁^{x} and the optimized third degree of freedom Δω₁^{z}, to get the optimized second degree of freedom Δω₂^{y}. Then S703 may be performed again, and Equation (16) may be resolved again according to the optimized first degree of freedom Δω₁^{x} and the optimized second degree of freedom Δω₁^{y}, to get the optimized third degree of freedom Δω₂^{z}. After every cycle that S701-S703 are performed once, the optimized first degree of freedom, the optimized second degree of freedom, and the optimized third degree of freedom may be updated once. As a number of the cycles of S701-S703 increases, the optimized first degree of freedom, the optimized second degree of freedom, and the optimized third degree of freedom may converge gradually. In one embodiment, the cycle S701-S703 may be performed continuously until the optimized first degree of freedom, the optimized second degree of freedom, and the optimized third degree of freedom converge. The optimized first degree of freedom, the optimized second degree of freedom, and the optimized third degree of freedom after converging, may be used as the first degree of freedom Δω^{x}, the second degree of freedom Δω^{y}, and the third degree of freedom Δω^{z} finally resolved by the present embodiment. Then according to the optimized first degree of freedom, the optimized second degree of freedom, and the optimized third degree of freedom after converging, the solution of the measurement error of the IMU may be determined, which may be denoted as (Δω^{x}, Δω^{y}, Δω^{z}).

In one embodiment, the first degree of freedom may represent a component of the measurement error in the X-axis of the coordination system of the IMU, the second degree of freedom may represent a component of the measurement error in the Y-axis of the coordination system of the IMU, and the third degree of freedom may represent a component of the measurement error in the Z-axis of the coordination system of the IMU.

In the present disclosure, the first degree of freedom, the second degree of freedom, and the third degree of freedom, may be cyclically optimized until the first degree of freedom, the second degree of freedom, and the third degree of freedom converge after optimization, to determine the measurement error of the IMU. The calculating accuracy of the measurement error of the IMU may be improved.

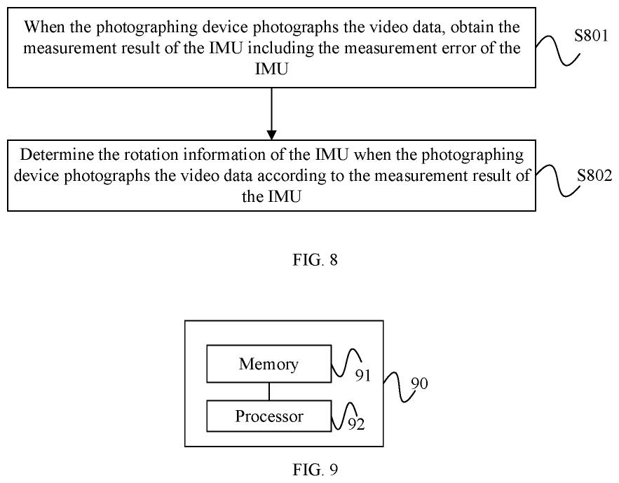

The present disclosure also provides another drift calibration method of the IMU. In one embodiment illustrated in FIG. 8, based on the above embodiments, after obtaining the video data captured by the photographing device, the method may further include:

S801: when the photographing device captures the video data, obtaining the measurement result of the IMU, where the measurement result may include the measurement error of the IMU; and

S802: determining the rotation information of the IMU when the photographing device captures the video data according to the measurement result of the IMU.

In one embodiment, the measurement result of the IMU may be the attitude information of the IMU. The attitude information of the IMU may include at least one of the angular velocity of the IMU, the rotation matrix of the IMU, or the quaternion of the IMU.

In one embodiment, the IMU may collect the angular velocity of the IMU at a first frequency, and the photographing device may collect the image information at a second frequency when photographing the video data. The first frequency may be larger than the second frequency.

For example, a capturing frame rate when the photographing device captures the video data may be f_{I}, that is a number of frames for the image captured by the photographing device per second when the photographing device captures the video data may be f₁. The IMU may collect the attitude information such as the angular velocity of the IMU at a frequency f_{w}, that is, the IMU may output the measurement result at a frequency f_{w}. f_{w} may be larger than f_{I}. That is, in a same time, the number of image frames captured by the photographing device may be smaller than a number of the measurement result outputted by the IMU.

In S802, the rotation information of the IMU when the photographing device captures the video data 20 may be determined according to the measurement result outputted by the IMU when the photographing device captures the video data 20.

In one embodiment, determining the rotation information of the IMU when the photographing device captures the video data according to the measurement result of the IMU, may include: integrating the measurement result of the IMU in a time period from the first exposure time of the first image frame to the second exposure time of the second image frame, to determine the rotation information of the IMU in the time period.

The measurement result of the IMU may include at least one of the angular velocity of the IMU, the rotation matrix of the IMU, or the quaternion of the IMU. When the photographing device captures the video data 20, the exposure time of the k-th image frame may be tₖ=k/f_{I}, and the exposure time of the (k+1)-th image frame may be tₖ₊₁=(k+1)/f_{I}. In the time period [tₖ,tₖ₊₁], the measurement result of the IMU may be integrated to determine the rotation information of the IMU in the time period [tₖ,tₖ₊₁].

In one embodiment, integrating the measurement result of the IMU in the time period from the first exposure time of the first image frame to the second exposure time of the second image frame, to determine the rotation information of the IMU in the time period may include: integrating the angular velocity of the IMU in the time period from the first exposure time of the first image frame to the second exposure time of the second image frame, to determine the rotation angle of the IMU in the time period.

The measurement result of the IMU may include the angular velocity of the IMU. When the photographing device captures the video data 20, the exposure time of the k-th image frame may be tₖ=k/f_{I}, and the exposure time of the (k+1)-th image frame may be tₖ₊₁=(k+1)/f_{I}. The angular velocity of the IMU in the time period [tₖ,tₖ₊₁] may be integrated to determine the rotation angle of the IMU in the time period [tₖ,tₖ₊₁].

In another embodiment, integrating the measurement result of the IMU in the time period from the first exposure time of the first image frame to the second exposure time of the second image frame, to determine the rotation information of the IMU in the time period may include: chain multiplying the rotation matrix of the IMU in the time period from the first exposure time of the first image frame to the second exposure time of the second image frame, to determine the rotation matrix of the IMU in the time period.

The measurement result of the IMU may include the rotation matrix of the IMU. When the photographing device captures the video data 20, the exposure time of the k-th image frame may be tₖ=k/f_{I}, and the exposure time of the (k+1)-th image frame may be tₖ₊₁=(k+1)/f_{I}, The rotation matrix of the IMU in the time period [tₖ,tₖ₊₁] may be multiplied continuously to determine the rotation matrix of the IMU in the time period [tₖ,tₖ₊₁].

In another embodiment, integrating the measurement result of the IMU in the time period from the first exposure time of the first image frame to the second exposure time of the second image frame, to determine the rotation information of the IMU in the time period may include: chain multiplying the quaternion of the IMU in the time period from the first exposure time of the first image frame to the second exposure time of the second image frame, to determine the quaternion of the IMU in the time period.

The measurement result of the IMU may include the quaternion of the IMU. When the photographing device captures the video data 20, the exposure time of the k-th image frame may be tₖ=k/f_{I}, and the exposure time of the (k+1)-th image frame may be tₖ₊₁=(k+1)/f_{I}, The quaternion of the IMU in the time period [tₖ,tₖ₊₁] may be chain multiplied to determine the quaternion of the IMU in the time period [tₖ,tₖ₊₁].

The above embodiments where the rotation information of the IMU is determined by the above methods are used as examples to illustrate the present disclosure, and should not limit the scopes of the present disclosure. In various embodiments, any suitable method may be used to determine the rotation information of the IMU.

In the present disclosure, when the photographing device captures the video data, the measurement result of the IMU may be achieved, and the rotation information of the IMU when the photographing device captures the video data may be determined by integrating the measurement result of the IMU. Since the measurement result of the IMU could be obtained, the measurement result of the IMU may be integrated to determine the rotation information of the IMU.

The present disclosure also provides a drift calibration device of an IMU. As illustrated in FIG. 9, in one embodiment, a drift calibration device 90 of an IMU may include: a memory 91 and a processor 92. The memory 91 may store a program code, and the processor 92 may call the program code. The program code may be executed to: obtain the video data captured by the photographing device; and determine the measurement error of the IMU according to the video data and the rotation information of the IMU when the photographing device captures the video data. The rotation information of the IMU may include the measurement error of the IMU.

The rotation information of the IMU may include at least one of a rotation angle, a rotation matrix, or a quaternion.

The processor 92 may determine the measurement error of the IMU according to the video data and the rotation information of the IMU when the photographing device captures the video data. In one embodiment, the processor 92 may determine the measurement error of the IMU according to a first image frame and a second image frame separated from the first image frame by a preset number of frames in the video data and the rotation information of the IMU in a time period from a first exposure time of the first image frame and a second exposure time of the second image frame.

The processor 92 may determine the measurement error of the IMU according to a first image frame and a second image frame separated from the first image frame by a preset number of frames in the video data and the rotation information of the IMU in a time period from a first exposure time of the first image frame and a second exposure time of the second image frame. In one embodiment, the processor 92 may determine the measurement error of the IMU according to a first image frame and a second image frame adjacent to the first image frame in the video data and the rotation information of the IMU in a time period from a first exposure time of the first image frame and a second exposure time of the second image frame.

In one embodiment, the process that the processor 92 determines the measurement error of the IMU according to a first image frame and a second image frame separated from the first image frame by a preset number of frames in the video data and the rotation information of the IMU in a time period from a first exposure time of the first image frame and a second exposure time of the second image frame, may include: performing feature extraction on the first image frame and the second image frame separated by a preset number of frames in the video data, to obtain a plurality of first feature points of the first image frame and a plurality of second feature points of the second image frame; performing feature point match on the plurality of first feature points of the first image frame and the plurality of second feature points of the second image frame; and determining the measurement error of the IMU according to matched first feature points and second feature points, and the rotation information of the IMU in a time from the first exposure time of the first image frame to the second exposure time of the second image frame.

In one embodiment, a process that the processor 92 determines the measurement error of the IMU according to matched first feature points and second feature points, and the rotation information of the IMU in a time from the first exposure time of the first image frame to the second exposure time of the second image frame, may include: determining projecting positions of the first feature points in the second image frame according to the first feature points and the rotation information of the IMU from the first exposure time of the first image frame to the second exposure time of the second image frame; determining a distance between the projecting position of each first feature point and a second feature point matching with the first feature point, according to the projecting positions of the first feature points in the second image frame and the matched second feature points; and determining the measurement error of the IMU according to the distance between the projecting position of each first feature point and a second feature point matching with the first feature point.

In one embodiment, a process that the processor 92 determines projecting positions of the first feature points in the second image frame according to the first feature points and the rotation information of the IMU from the first exposure time of the first image frame to the second exposure time of the second image frame may include: determining the projecting positions of the first feature points in the second image frame according to the positions of the first feature points in the first image frame, the rotation information of the IMU from the first exposure time of the first image frame to the second exposure time of the second image frame, a relative attitude between the photographing device and the IMU, and the internal parameter of the photographing device. In various embodiment, the internal parameter of the photographing device may include at least one of a focal length of the photographing device, or a pixel size of the photographing device.

In one embodiment, a process that the processor 92 determines the measurement error of the IMU according to the distance between the projecting position of each first feature point and a second feature point matching with the first feature point may include: optimizing the distance between the projecting position of each first feature point and a second feature point matching with the first feature point, to determine the measurement error of the IMU.

In one embodiment, a process that the processor 92 optimizes the distance between the projecting position of each first feature point and a second feature point matching with the first feature point, to determine the measurement error of the IMU may include: minimizing the distance between the projecting position of each first feature point and a second feature point matching with the first feature point, to determine the measurement error of the IMU.

A working principle and realization method of the drift calibration device can be referred to the embodiment illustrated in FIG. 1.

In the present disclosure, when the photographing device captures the video data, the rotation information of the IMU during the photographing device captures the video data may be determined. The rotation information of the IMU may include the measurement error of the IMU. Since the video data and the measurement result of the IMU can be obtained accurately, the determined measurement error of the IMU according to the video data and the rotation information of the IMU may be accurate, and a computing accuracy of the moving information of the movable object may be improved.

The present disclosure provides another drift calibration device. Based on the embodiment illustrated in FIG. 9, in one embodiment, the measurement error of the IMU may include a first degree of freedom, a second degree of freedom, and a third degree of freedom.

Correspondingly, in one embodiment, a process that the processor 92 optimizes the distance between the projecting position of each first feature point and a second feature point matching with the first feature point, to determine the measurement error of the IMU may include: optimizing the distance between the projecting position of each first feature point and a second feature point matching with the first feature point according to the preset second degree of freedom and the preset third degree of freedom, to get the optimized first degree of freedom; optimizing the distance between the projecting position of each first feature point and a second feature point matching with the first feature point according to the optimized first degree of freedom and the preset third degree of freedom, to get the optimized second degree of freedom; optimizing the distance between the projecting position of each first feature point and a second feature point matching with the first feature point according to the optimized first degree of freedom and the optimized second degree of freedom, to get the optimized third degree of freedom; and cyclically optimizing the first degree of freedom, the second degree of freedom, and the third degree of freedom, until the first degree of freedom, the second degree of freedom, and the third degree of freedom converge after optimization, to determine the measurement error of the IMU.

In another embodiment, a process that the processor 92 optimizes the distance between the projecting position of each first feature point and a second feature point matching with the first feature point, to determine the measurement error of the IMU may include: optimizing the distance between the projecting position of each first feature point and a second feature point matching with the first feature point according to the preset second degree of freedom and the preset third degree of freedom, to get the optimized first degree of freedom; optimizing the distance between the projecting position of each first feature point and a second feature point matching with the first feature point according to the preset first degree of freedom and the preset third degree of freedom, to get the optimized second degree of freedom; optimizing the distance between the projecting position of each first feature point and a second feature point matching with the first feature point according to the preset first degree of freedom and the preset second degree of freedom, to get the optimized third degree of freedom; and cyclically optimizing the first degree of freedom, the second degree of freedom, and the third degree of freedom, until the first degree of freedom, the second degree of freedom, and the third degree of freedom converge after optimization, to determine the measurement error of the IMU.

In one embodiment, the first degree of freedom may represent a component of the measurement error in the X-axis of the coordination system of the IMU, the second degree of freedom may represent a component of the measurement error in the Y-axis of the coordination system of the IMU, and the third degree of freedom may represent a component of the measurement error in the Z-axis of the coordination system of the IMU. The distance may include at least one of a Euclidean distance, an urban distance, or a Mahalanobis distance.

A working principle and realization method of the drift calibration device in the present embodiment can be referred to the embodiment illustrated in FIGS. 6-7.

In the present disclosure, the first degree of freedom, the second degree of freedom, and the third degree of freedom, may be cyclically optimized until the first degree of freedom, the second degree of freedom, and the third degree of freedom converge after optimization, to determine the measurement error of the IMU. The calculating accuracy of the measurement error of the IMU may be improved.

The present disclosure also provides another drift calibration device. In one embodiment, based on the embodiment illustrated in FIG. 9, after the processor 92 obtains the video data captured by the photographing device, the measurement result of the IMU when the photographing device captures the video data may be obtained, and the rotation information of the IMU when the photographing device captures the video data according to the measurement result of the IMU may be determined. The measurement result may include the measurement error of the IMU.

In one embodiment, the IMU may collect the angular velocity of the IMU at a first frequency, and the photographing device may collect the image information at a second frequency when photographing the video data. The first frequency may be larger than the second frequency.

In one embodiment, a process that the processor 92 determines the rotation information of the IMU when the photographing device captures the video data according to the measurement result of the IMU, may include: integrating the measurement result of the IMU in a time period from the first exposure time of the first image frame to the second exposure time of the second image frame, to determine the rotation information of the IMU in the time period.

In one embodiment, a process that the processor 92 integrates the measurement result of the IMU in the time period from the first exposure time of the first image frame to the second exposure time of the second image frame, to determine the rotation information of the IMU in the time period may include: integrating the angular velocity of the IMU in the time period from the first exposure time of the first image frame to the second exposure time of the second image frame, to determine the rotation angle of the IMU in the time period.

In another embodiment, a process that the processor 92 integrates the measurement result of the IMU in the time period from the first exposure time of the first image frame to the second exposure time of the second image frame, to determine the rotation information of the IMU in the time period may include: chain multiplying the rotation matrix of the IMU in the time period from the first exposure time of the first image frame to the second exposure time of the second image frame, to determine the rotation matrix of the IMU in the time period.

In another embodiment, a process that the processor 92 integrates the measurement result of the IMU in the time period from the first exposure time of the first image frame to the second exposure time of the second image frame, to determine the rotation information of the IMU in the time period may include: chain multiplying the quaternion of the IMU in the time period from the first exposure time of the first image frame to the second exposure time of the second image frame, to determine the quaternion of the IMU in the time period.

In one embodiment, after the processor 92 determines the measurement error of the IMU according to the video data and the rotation information of the IMU when the photographing device captures the video data, the processor 92 may further calibrate the measurement result of the IMU according to the measurement error of the IMU.

In the present disclosure, when the photographing device captures the video data, the measurement result of the IMU may be achieved, and the rotation information of the IMU when the photographing device captures the video data may be determined by integrating the measurement result of the IMU. Since the measurement result of the IMU could be obtained, the measurement result of the IMU may be integrated to determine the rotation information of the IMU.

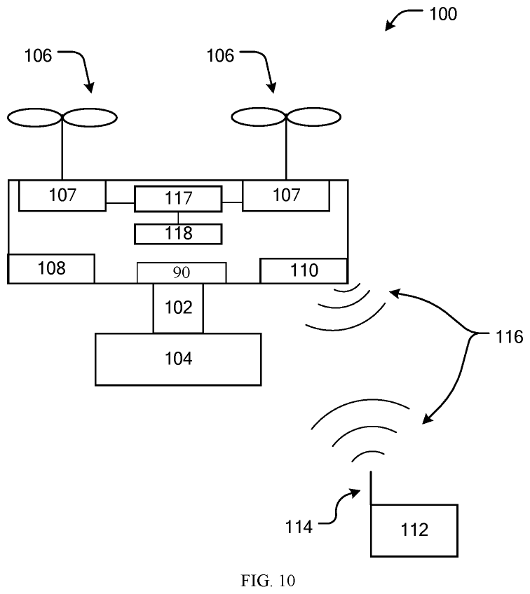

The present disclosure also provides an unmanned aerial vehicle. As illustrated in FIG. 10, the unmanned aerial vehicle 100 in one embodiment may include: a body, a propulsion system, and a flight controller 118. The propulsion system may include at least one of a motor 107, a propeller 106, or an electronic speed governor 117. The propulsion system may be mounted on the body, to provide a flight propulsion. The flight controller 118 may be connected to the propulsion system in communication, to control the flight of the unmanned aerial vehicle.

The unmanned aerial vehicle 100 may further include a sensor system 108, a communication system 110, a support system 102, a photographing device 104, and a drift calibration device 90. The support system 102 may be a head. The communication system 110 may include a receiver for receiving wireless signals from an antenna 114 in a ground station 112. Electromagnetic wave 116 may be produced during the communication between the receiver and the antenna 114. The photographing device may photograph video data. The photographing device may be disposed in a printed circuit board (PCB) same as the IMU, or may be rigidly connected to the IMU. The drift calibration device 90 may be any drift calibration device provided by the above embodiments of the present disclosure.

In the present disclosure, when the photographing device captures the video data, the rotation information of the IMU during the photographing device captures the video data may be determined. The rotation information of the IMU may include the measurement error of the IMU. Since the video data and the measurement result of the IMU can be obtained accurately, the determined measurement error of the IMU according to the video data and the rotation information of the IMU may be accurate, and a computing accuracy of the moving information of the movable object may be improved.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of example systems, devices, and units may be omitted and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments but may be embodied in other equivalent forms without departing from the scope of the present disclosure, which is determined by the appended claims.

What is claimed is:

1. A drift calibration method of an inertial measurement unit, comprising:
obtaining video data captured by a photographing device; and
determining a measurement error of the inertial measurement unit according to the video data and rotation information of the inertial measurement unit when the photographing device capturing the video data,
wherein the rotation information of the inertial measurement unit includes the measurement error of the inertial measurement unit.

2. The method according to claim 1, wherein:
determining the measurement error of the inertial measurement unit according to the video data and the rotation information of the inertial measurement unit when the photographing device captures the video data includes: determining the measurement error of the inertial measurement unit according to a first image frame and a second image frame separated from the first image frame by a preset number of frames in the video data, and the rotation information of the inertial measurement unit in a time period from a first exposure time of the first image frame to a second exposure time of the second image frame.

3. The method according to claim 2, wherein determining the measurement error of the inertial measurement unit according to the first image frame and the second image frame separated from the first image frame by the preset number of frames in the video data and the rotation information of the inertial measurement unit in the time period from the first exposure time of the first image frame to the second exposure time of the second image frame, includes:
determining the measurement error of the inertial measurement unit according to the first image frame and the second image frame adjacent to the first image frame in the video data, and the rotation information of the inertial measurement unit in the time period from the first exposure time of the first image frame to the second exposure time of the second image frame.

4. The method according to claim 2, wherein determining the measurement error of the inertial measurement unit according to the first image frame and the second image frame separated from the first image frame by the preset number of frames in the video data and the rotation information of the inertial measurement unit in the time period from the first exposure time of the first image frame to the second exposure time of the second image frame, includes:
performing feature extraction on the first image frame and the second image frame separated from the first image frame by the preset number of frames in the video data respectively, to get a plurality of first feature points of the first image frame and a plurality of second feature points of the second image frame;
performing feature point matching on the plurality of first feature points of the first image frame and the plurality of second feature points of the second image frame; and
determining the measurement error of the inertial measurement unit according to matched first feature points and second feature points, and the rotation information of the inertial measurement unit in the time period from the first exposure time of the first image frame to the second exposure time of the second image frame.

5. The method according to claim 4, wherein, determining the measurement error of the inertial measurement unit according to the matched first feature points and second feature points, and the rotation information of the inertial measurement unit in the time period from the first exposure time of the first image frame to the second exposure time of the second image frame, includes:
determining a projecting position of each first feature point onto the second image frame according to the first feature point and the rotation information of the inertial measurement unit in the time period from the first exposure time of the first image frame to the second exposure time of the second image frame;
determining a distance between the projecting position of each first feature point and a second feature point matching with the first feature point, according to the projecting position of the first feature point onto the second image frame and the second feature point matching with the first feature point; and
determining the measurement error of the inertial measurement unit according to the distance between the projecting position of each first feature point and the second feature point matching with the first feature point.

6. The method according to claim 5, wherein determining the projecting position of each first feature point onto the second image frame according to the first feature point and the rotation information of the inertial measurement unit in the time period from the first exposure time of the first image frame to the second exposure time of the second image frame, includes:
determining the projecting position of each first feature point onto the second image frame according to a position of the first feature point of the first image frame, the rotation information of the inertial measurement unit in the time period from the first exposure time of the first image frame to the second exposure time of the second image frame, a relative attitude between the photographing device and the inertial measurement unit, and an internal parameter of the photographing device.

7. The method according to claim 5, wherein determining the measurement error of the inertial measurement unit according to the distance between the projecting position of each first feature point and the second feature point matching with the first feature point, includes:
determining the measurement error of the inertial measurement unit by optimizing a distance between the projecting position of each first feature point and the second feature point matching with the first feature point.

8. The method according to claim 7, wherein, determining the measurement error of the inertial measurement unit by optimizing the distance between the projecting position of each first feature point and the second feature point matching with the first feature point includes:
determining the measurement error of the inertial measurement unit by minimizing the distance between the projecting position of each first feature point and the second feature point matching with the first feature point.

9. The method according to claim 8, wherein:
the measurement error of the inertial measurement unit includes a first degree of freedom, a second degree of freedom, and a third degree of freedom.

10. The method according to claim 9, wherein determining the measurement error of the inertial measurement unit by optimizing the distance between the projecting position of each first feature point and the second feature point matching with the first feature point includes:
optimizing the distance between the projecting position of each first feature point and the second feature point matching with the first feature point according to the preset first degree of freedom and the preset third degree of freedom, to get the optimized second degree of freedom;
optimizing the distance between the projecting position of each first feature point and the second feature point matching with the first feature point according to the optimized first degree of freedom and the preset third degree of freedom, to get the optimized second degree of freedom;
optimizing the distance between the projecting position of each first feature point and the second feature point matching with the first feature point according to the optimized first degree of freedom and the optimized second degree of freedom, to get the optimized third degree of freedom; and
cyclically optimizing the first degree of freedom, the second degree of freedom, and the third degree of freedom, until the first degree of freedom, the second degree of freedom, and the third degree of freedom converge after optimization, to determine the measurement error of the inertial measurement unit.

11. The method according to claim 9, wherein determining the measurement error of the inertial measurement unit by optimizing the distance between the projecting position of each first feature point and the second feature point matching with the first feature point includes:
optimizing the distance between the projecting position of each first feature point and the second feature point matching with the first feature point according to the preset first degree of freedom and the preset third degree of freedom, to get the optimized second degree of freedom;
optimizing the distance between the projecting position of each first feature point and the second feature point matching with the first feature point according to the preset first degree of freedom and the preset third degree of freedom, to get the optimized second degree of freedom;
optimizing the distance between the projecting position of each first feature point and the second feature point matching with the first feature point according to the preset first degree of freedom and the preset second degree of freedom, to get the optimized third degree of freedom; and
cyclically optimizing the first degree of freedom, the second degree of freedom, and the third degree of freedom, until the first degree of freedom, the second degree of freedom, and the third degree of freedom converge after optimization, to determine the measurement error of the inertial measurement unit.

12. The method according to claim 8, wherein:
the first degree of freedom represents a component of the measurement along an X-axis of a coordination system of the inertial measurement unit;
the second degree of freedom represents a component of the measurement along a Y-axis of a coordination system of the inertial measurement unit; and
the third degree of freedom represents a component of the measurement along a Z-axis of a coordination system of the inertial measurement unit.

13. The method according to claim 2, after obtaining the video data captured by the photographing device, further including:
obtaining a measurement result of the inertial measurement unit when the photographing device captures the video data, wherein the measurement result includes the measurement error of the inertial measurement unit; and
determining the rotation information of the inertial measurement unit when the photographing device captures the video data according to the measurement result of the inertial measurement unit.

14. The method according to claim 13, wherein:
the inertial measurement unit collects an angular velocity of the inertial measurement unit at a first frequency;
the photographing device collects image information at a second frequency when the photographing device captures the video data; and
the first frequency is larger than the second frequency.

15. The method according to claim 13, wherein determining the rotation information of the inertial measurement unit when the photographing device captures the video data according to the measurement result of the inertial measurement unit includes:
integrating the measurement result of the inertial measurement unit in the time period from the first exposure time of the first image frame to the second exposure time of the second image frame, to determine the rotation information of the inertial measurement unit in the time period.

16. The method according to claim 15, wherein, integrating the measurement result of the inertial measurement unit in the time period from the first exposure time of the first image frame to the second exposure time of the second image frame, to determine the rotation information of the inertial measurement unit in the time period, includes:
integrating an angular velocity of the inertial measurement unit in the time period from the first exposure time of the first image frame to the second exposure time of the second image frame, to determine the rotation information of the inertial measurement unit in the time period.

17. The method according to claim 15, wherein, integrating the measurement result of the inertial measurement unit in the time period from the first exposure time of the first image frame to the second exposure time of the second image frame, to determine the rotation information of the inertial measurement unit in the time period, includes:
integrating a rotation matrix of the inertial measurement unit in the time period from the first exposure time of the first image frame to the second exposure time of the second image frame by continuous multiplication, to determine the rotation information of the inertial measurement unit in the time period.

18. The method according to claim 15, wherein, integrating the measurement result of the inertial measurement unit in the time period from the first exposure time of the first image frame to the second exposure time of the second image frame, to determine the rotation information of the inertial measurement unit in the time period, includes:
integrating a quaternion of the inertial measurement unit in the time period from the first exposure time of the first image frame to the second exposure time of the second image frame by continuous multiplication, to determine the rotation information of the inertial measurement unit in the time period.

19. A drift calibration device of an inertial measurement unit, comprising a memory and a processor, wherein:
the memory is configured to store programming codes; and
when the program codes being executed, the processor is configured for:
obtaining video data captured by a photographing device; and
determining a measurement error of the inertial measurement unit according to the video data and rotation information of the inertial measurement unit when the photographing device capturing the video data,
wherein the rotation information of the inertial measurement unit includes the measurement error of the inertial measurement unit.

20. An unmanned aerial vehicle, comprising:
a fuselage,
a propulsion system, installed at the fuselage, to provide a flying propulsion;
a flight controller, communication connected to the propulsion system, to control a flight of the unmanned aerial vehicle;
a photographing device, to capture video data; and
a drift calibration device including a memory and a processor, wherein:
the memory is configured to store programming codes; and
when the program codes being executed, the processor is configured for:
obtaining video data captured by a photographing device; and
determining a measurement error of the inertial measurement unit according to the video data and rotation information of the inertial measurement unit when the photographing device capturing the video data,
wherein the rotation information of the inertial measurement unit includes the measurement error of the inertial measurement unit.
